(19) United States
(12) Patent Application Publication
(10) Pub. No.: US 2024/0087284 A1
(43) Pub. Date: Mar. 14, 2024

(54) SYSTEMS AND METHODS FOR OBJECT IMAGE CAPTURING AND IDENTIFICATION

(71) Applicant: Osama H. Tarraf, Fairfax, VA (US)

(72) Inventor: Osama H. Tarraf, Fairfax, VA (US)

(21) Appl. No.: 18/227,905

(22) Filed: Jul. 29, 2023

Related U.S. Application Data
(60) Provisional application No. 63/405,423, filed on Sep. 10, 2022.

(51) Int. Cl. G06V 10/75; G06Q 30/018; G06V 20/70

(52) U.S. Cl. CPC G06V 10/75; G06Q 30/018; G06V 20/70

(57) ABSTRACT

A method of image processing comprising the steps of generating one or more images of an object utilizing a first technology; transferring the one or more images of the object to a processor; utilizing the processor to capture the one or more images of the object; labeling the one or more images of the object with one or more object properties; and saving the one or more images of the object to a database.

### PRIORITY CLAIM

This non-provisional patent application claims the benefit of U.S. Provisional Application No. 63/405,423 filed on Sep. 10, 2022, the entirety of which is incorporated herein by reference.

### FIELD

Object identification is important for many fields such as proofing of ownership, issuing certificate of Origin for an object and/or counterfeiting detection. Serial numbers are used for identification, but it can be easily counterfeited. Other high tech methods can be used such as RFID can be attached to the object, but it can be removed or replaced. There is a need for a method or apparatus to do this kind of identification that depends on the object itself. In certain arrangements, the macrostructure and/or microstructure of an object's gains can be used as a unique identifier for the object. It can be used as a “fingerprint” for each object.

### BACKGROUND

When an object is manufactured using casting, extrusion, forming or other similar manufacturing techniques, the structural features on the micro- or macro-level are extremely unique depending on the manufacturing technique. Moreover, the probability to produce two identical samples on the microstructure level is exceptionally low even on a laboratory scale.

For example, considering the casting process, the solidification of a metal inside the desired mold is controlled by nucleation and growth phenomena. Depending on the purity of the metal, homogenous nucleation and clustering of atoms are governed in pure metals while a low amount of impurities might lead to a heterogenous nucleation mechanism which indeed generates a solidified microstructure different from that in pure metal. In any case, each nucleus grows in a unique orientation based on the direction of cooling forming crystal. Each crystal has its unique orientation, and the crystals are intersecting together in random oriented atoms zone called grain boundaries. The microstructure image of an object's gains can be used as a unique identifier for the object. It can be used as a do called “fingerprint” for each object as it depends on level of impurities, cooling rate and direction.

### SUMMARY

In one arrangement, a method of image processing comprising the steps of generating one or more images of an object utilizing a first technology; transferring the one or more images of the object to a processor; utilizing the processor to capture the one or more images of the object; labeling the one or more images of the object with one or more object properties; and saving the one or more images of the object to a database.

In one arrangement, the method further comprising the step of evaluating the one or more images; and tracking an ownership of the object which can be current or historical ownership; wherein the step of tracking the ownership of the object utilizes blockchain technology.

In one arrangement, the method further comprising the step of utilizing the blockchain technology to encrypt information related to the ownership of the object.

In one arrangement, the captured one or more images saved to the database comprises a two-dimensional image.

In one arrangement, the one or more images saved to the database comprises a partial two-dimensional image.

In one arrangement, the one or more images saved to the database comprises a three-dimensional image.

In one arrangement, the one or more images saved to the database comprises a partial three-dimensional image.

In one arrangement, the first technology utilized for generating one or more images of the object is selected from a group comprising microscopy, x-ray diffraction, or 3D x-ray diffraction.

In one arrangement, the one or more images are associated with an identification number.

In one arrangement, the one or more images are associated with one or more object properties of the object.

In one arrangement, the one or more object properties is selected from the group including an identification number, a manufacturer of the object, a manufacturing date of the object, an alloy property of the object, or an owner of the object.

In one arrangement, the step of labeling the one or more images of the object with one or more object properties occurs manually.

In one arrangement, the step of labeling the one or more images of the object with one or more object properties occurs automatically.

In one arrangement, the step of utilizing a cloud computing environment to perform one or more steps of the image processing.

In one arrangement, the database comprises one or more object entries selected from the group comprising an object unique identification, object original imaging, at least one object feature, a date of addition to the database, an object manufacturing date, an object manufacturer identification, an object specification or an object model number.

In one arrangement, the method further comprising the step of performing imaging the object utilizing a second technology; and capturing one or more second imaging features of the object.

In one arrangement, the method further comprising the step of evaluating the captured images of the object during imaging of the object utilizing the second technology with the first set of images captured during the first imaging using the first technology.

In one arrangement, the first technology is substantially similar to the second technology.

In one arrangement, the method further comprises the step of utilizing AI to evaluate the captured images of the object by utilizing the second technology.

In one arrangement, the method further comprising the step of identifying similar images and/or features collected in the database during the first imaging process with the one or more second imaging features of the object.

In one arrangement, the method further comprising the step of identifying images and/or features that will be used to pull the corresponding object information from the database collected during the first technology.

In one arrangement, the method further comprising the step of validating that the object is matching a specific object from the database object collected during the first technology.

In one arrangement, the database comprises an SQL database.

In one arrangement, the method further comprising the step of tracking one or more historical changes to the object.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an exemplary system for the object fingerprinting according to examples of the disclosure; and

FIG. 2 shows an exemplary system for database object search according to examples of the disclosure.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

This disclosure includes details to implementations and embodiments of various aspects and variations of the systems and methods described herein. The disclosure includes description of several examples of the variations of the systems and method described herein. Other variations of different suitable combinations of aspect of the systems and methods described herein are considered variations of the systems and methods described herein.

According to an aspect, an image capturing system captures unique images for objects. In one or more examples, the images can be captured one or more methods including Microscopy, XRD (X-Ray Diffraction) for limited subsurface analysis, 3D X-ray CT scan or any other imaging technology. In one or more examples, these images can be for a two-dimensional and/or three dimensional images of the surfaces. In one or more examples, these images can be for full or partial three-dimensional image of the object including the surface and/or subsurface and/or deep inside the object. In one or more examples, the image will be saved for later use. In one or more examples, the image can be associated with an identification number and/or many other properties of the object. In one or more examples, the properties of an object, that was previously associated with the object, can be retrieved later by taking an image of the object and find the similar image captured earlier.

In one or more examples, the object properties can include but not limited to ID number and/or Manufacturer and/or Manufacturing date and/or Alloy properties and/or Owner and/or other properties.

According to an aspect, an object identification system identifies an object. In one or more examples, the object image will be captured. In one or more examples, the captured images will be evaluated against previously captured images by image capturing system. In one or more examples, the evaluation can be done by searching, comparing, and/or locating a previously captured image of the object by image capturing system. Because of the uniqueness of these imaging among objects, this method can be used to identify objects and/or distinguish between different objects.

According to an aspect, an objects ownership can be tracked to include current and/or historical ownership. In one or more examples, blockchain technology can be used to track current and/or historical owners.

Some aspects of the disclosure include algorithms. The steps and instructions of these algorithms could be embodied in software, firmware and/or hardware. When these steps and instructions embodied in software, these steps and instructions could be downloaded from different platforms.

It is to be understood that the terms “processing,” “process,” “computing,” “compute,” “calculating,” “calculate,” determining,” “determine,” “displaying,” “display,” “generating,” “generate” or the like refer to the action and processes of a computer systems or similar electronic computing device.

In some embodiments, the operations could be performed in a device. This device could be a computer system operated by a computer program. The program can be stored in a computer readable storage medium.

It is to be understood that the terms “images,” “image,” “imaging” or the like refer to the action of capturing the image or images. It is to be understood that the terms “images,” “image,” “imaging” or the like refer to the image or images captured by any imaging technology.

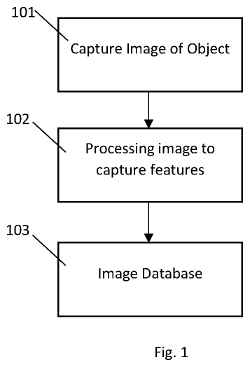

FIG. 1 shows an exemplary system for the object fingerprinting according to examples of the disclosure. In one or more examples of the disclosure, illustrate an exemplary method or the apparatus shall include, but not limited to, imaging step 101, where the 2D or 3D, or 3D subsurface images of the object is captured, processing step (102) to capture image features and/or storage step 103, to save the images, specifications and/or features in a database.

In one or more examples of the disclosure, in the imaging step 101, can be conducted using 2D and/or 3D imaging and/or 3D sub surface imaging to the object as indicated above. The images will be transferred to the processor which will capture the image features, label the images and/or add more object properties that can be entered manually or automatically. The processor will save the object features, properties, labels and/or images to the database.

The whole system or part of the system can be fully automated or run manually. The transfer of imaging, data, properties and/or labels can be automated or manually. The system building blocks can run on single device or divided on multiple devices. An implementation of the system can be performed within a cloud computing environment.

The database can contain object entries that has information about the object such as, but not limited to, object unique identification, object original imaging, object features, date of addition to the database, object manufacturing date, object manufacturer identification, object specifications and/or object model number.

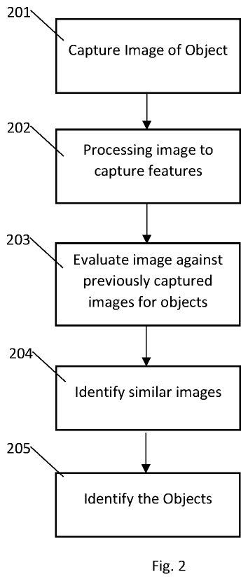

FIG. 2 shows an exemplary system for database object search according to examples of the disclosure. In one or more examples of the disclosure, when an object is required to be identified, imaging will be conducted in step 201. In one or more examples of the disclosure, this imaging can be done with the same and/or different technologies as in the fingerprinting phase. For example, this imaging may be accomplished with lower resolution and/or partial imagining compared to the fingerprinting phase can be used in step 201. In one or more examples of the disclosure, in step 202, the image or images of the object will be processed to capture the image features. In one or more examples of the disclosure, in step 203, evaluating the image against previously captured images and/or features collected in the database, during the fingerprinting phase, will be conducted. In one or more examples of the disclosure, in step 204, the captured image evaluation result will be used to identify the similar images/features collected in the database, during the fingerprinting phase. In one or more examples of the disclosure, in step 205, the identified images/features will be used to pull the corresponding object information from the database collected during the fingerprinting phase.

In one or more examples of the disclosure the process in steps 202, 203 and/or 204 can be used in validating that the object is matching a specific object from the database objects collected during the fingerprinting phase or indicate that this object has no match in the database.

In one or more examples of the disclosure, the matching process in steps 202,203 and/or 204 can be done to find the closest database objects' entries to the object and/or rank each entry with respect to how close it is to the object. This will increase the correctness of matching in many cases of object changes due to, but not limited to, the change of shape due to tear and/or wear, using different lighting and/or using imaging methods, technologies and/or resolutions in the search phase different than fingerprinting phase.

In the database object search, in one or more examples of the disclosure, in case the object identification number is known, a comparison will be conducted between the database entries for this object's unique identification and the captured images of the object to validate the match. The object validation system works in a similar way to the database object search system in FIG. 2; however, in one preferred arrangement, it does not conduct a search. The system will only compare the images to specific images in the database.

According to an aspect, an objects entry can contain information to track the ownership of the object to include current and/or historical ownership. In one or more examples, blockchain technology can be used to create an immutable ledger of historical and/or current ownership.

In one or more examples of the disclosure the database can include, but not limited to, conventional databases including SQL and/or NoSQL databases, file storage and/or blockchain immutable ledger.

In one or more examples of the disclosure the blockchain technology can be used to validate the accuracy of stored information in the database.

In one or more examples of the disclosure the blockchain technology can be used to validate the accuracy of information exchanged between different parts of the system.

In one or more examples of the disclosure the blockchain technology can be used to encrypt information exchange or saved in any part of the system.

In one or more examples of the disclosure, in the steps of the fingerprinting phase and/or the database object search system in FIG. 1 and FIG. 2, traditional image processing, artificial intelligence and/or machine learning technologies can be used to detect, but not limited to, errors, anomalies, features, colors, similarity and/or type of material.

In one or more examples of the disclosure, in steps 202, 203 and/or 204 of FIG. 2, traditional image processing, artificial intelligence and/or machine learning technologies can be used to compare the captured object with the database entries collected during fingerprinting phase.

In one or more examples of the disclosure, an image captured by the database object search system and associated to a specific object can be used to update the object's database entries to keep track of the historical changes to the object and/or to be used in identification of the object in future searches. These images can be ingested and/or utilized in a way similar to the fingerprinting phase.

In one or more examples of the disclosure, the fingerprinting process can be repeated for the object to update older fingerprints.

In one or more examples of the disclosure, the fingerprinting process can be repeated for the object to keep track of for monitoring fingerprinting over time.

In one or more examples of the disclosure, when the multiple fingerprints are available for an object over time, the database object search system can consider the changes over time as a weighted parameter in search process.

FIG. 1 shows an exemplary method for the object fingerprinting according to examples of the disclosure. In one or more examples of the disclosure, illustrate an exemplary method or the apparatus shall include, but not limited to, imaging step 101, where the 2D or 3D, or 3D subsurface images of the object is captured, processing step (102) to capture image features and/or storage step 103, to save the images, specifications and/or features in a database.

In one or more examples of the disclosure, in the imaging step 101, can be conducted using 2D and/or 3D imaging and/or 3D sub surface imaging to the object as indicated above. The images will be transferred to the processor which will capture the image features, label the images and/or add more object properties that can be entered manually or automatically. The processor will save the object features, properties, labels and/or images to the database.

The whole method or part of the method can be fully automated or run manually. The transfer of imaging, data, properties and/or labels can be automated or manually. The method building blocks can run on single device or divided on multiple devices. An implementation of the method can be performed via a cloud computing environment.

The database can contain object entries that has information about the object such as, but not limited to, object unique identification, object original imaging, object features, date of addition to the database, object manufacturing date, object manufacturer identification, object specifications and/or object model number.

FIG. 2 shows an exemplary method for database object search according to examples of the disclosure. In one or more examples of the disclosure, when an object is required to be identified, imaging will be conducted in step 201. In one or more examples of the disclosure, this imaging can be done with the same and/or different technologies as in the fingerprinting phase. For example, lower resolution and/or partial imagining compared to the fingerprinting phase can be used in step 201. In one or more examples of the disclosure, in step 202, the image or images of the object will be processed to capture the image features. In one or more examples of the disclosure, in step 203, evaluating the image against previously captured images and/or features collected in the database, during the fingerprinting phase, will be conducted. In one or more examples of the disclosure, in step 204, the captured image evaluation result will be used to identify the similar images/features collected in the database, during the fingerprinting phase. In one or more examples of the disclosure, in step 205, the identified images/features will be used to pull the corresponding object information from the database collected during the fingerprinting phase.

In one or more examples of the disclosure the process in steps 202, 203 and/or 204 can be used in validating that the object is matching a specific object from the database objects collected during the fingerprinting phase or indicate that this object has no match in the database.

In one or more examples of the disclosure, the matching process in steps 202, 203 and/or 204 can be done to find the closest database objects' entries to the object and/or rank each entry with respect to how close it is to the object. This will increase the correctness of matching in many cases of object changes due to, but not limited to, the change of shape due to tear and/or wear, using different lighting and/or using imaging methods, technologies and/or resolutions in the search phase different than fingerprinting phase.

In the database object search, in one or more examples of the disclosure, in case the object identification number is known, a comparison will be conducted between the database entries for this object's unique identification and the captured images of the object to validate the match. The object validation method works in a similar way to the database object search method in FIG. 2; however, it does not conduct a search. The method will only compare the images to specific images in the database.

According to an aspect, an objects entry can contain information to track the ownership of the object to include current and/or historical ownership. In one or more examples, blockchain technology can be used to create an immutable ledger of historical and/or current ownership.

In one or more examples of the disclosure the database can include, but not limited to, conventional databases including SQL and/or NoSQL databases, file storage and/or blockchain immutable ledger.

In one or more examples of the disclosure the blockchain technology can be used to validate the accuracy of stored information in the database.

In one or more examples of the disclosure the blockchain technology can be used to validate the accuracy of information exchanged between different parts of the method.

In one or more examples of the disclosure the blockchain technology can be used to encrypt information exchange or saved in any part of the method.

In one or more examples of the disclosure, in all the steps of the fingerprinting phase and/or the database object search method in FIG. 1 and FIG. 2, traditional image processing, artificial intelligence and/or machine learning technologies can be used to detect, but not limited to, errors, anomalies, features, colors, similarity and/or type of material.

In one or more examples of the disclosure, in steps 202, 203 and/or 204 of FIG. 2, traditional image processing, artificial intelligence and/or machine learning technologies can be used to compare the captured object with the database entries collected during fingerprinting phase.

In one or more examples of the disclosure, an image captured by the database object search method and associated to a specific object can be used to update the object's database entries to keep track of the historical changes to the object and/or to be used in identification of the object in future searches. These images can be ingested and/or utilized in similar way similar to the fingerprinting phase.

In one or more examples of the disclosure, the fingerprinting process can be repeated for the object to update older fingerprints.

In one or more examples of the disclosure, the fingerprinting process can be repeated for the object to keep track of fingerprinting over time.

In one or more examples of the disclosure, when the multiple fingerprints are available for an object over time, the database object search method can consider the changes over time as a weighted parameter in search process.

FIG. 1 shows an exemplary non transitory computer readable storage storing one or more programs for the object fingerprinting according to examples of the disclosure. In one or more examples of the disclosure, illustrate an example or the apparatus shall include, but not limited to, Imaging step 101, where the 2D or 3D, or 3D subsurface images of the object is captured, processing step (102) to capture image features and/or storage step 103, to save the images, specifications and/or features in a database.

In one or more examples of the disclosure, in the imaging step 101, can be conducted using 2D and/or 3D imaging and/or 3D sub surface imaging to the object as indicated above. The images will be transferred to the processor which will capture the image features, label the images and/or add more object properties that can be entered manually or automatically. The processor will save the object features, properties, labels and/or images to the database.

The whole or part of the non transitory computer readable storage storing one or more programs can be fully automated or run manually. The transfer of imaging, data, properties and/or labels can be automated or manually. The programs building blocks can run on single device or divided on multiple devices. An implementation of the programs can be performed on a cloud computing environment.

The database can contain object entries that has information about the object such as, but not limited to, object unique identification, object original imaging, object features, date of addition to the database, object manufacturing date, object manufacturer identification, object specifications and/or object model number.

FIG. 2 shows an exemplary program for database object search according to examples of the disclosure. In one or more examples of the disclosure, when an object is required to be identified, imaging will be conducted in step 201. In one or more examples of the disclosure, this imaging can be done with the same and/or different technologies as in the fingerprinting phase. For example, lower resolution and/or partial imagining compared to the fingerprinting phase can be used in step 201. In one or more examples of the disclosure, in step 202, the image or images of the object will be processed to capture the image features. In one or more examples of the disclosure, in step 203, evaluating the image against previously captured images and/or features collected in the database, during the fingerprinting phase, will be conducted. In one or more examples of the disclosure, in step 204, the captured image evaluation result will be used to identify the similar images/features collected in the database, during the fingerprinting phase. In one or more examples of the disclosure, in step 205, the identified images/features will be used to pull the corresponding object information from the database collected during the fingerprinting phase.

In one or more examples of the disclosure, the process in steps 202,203 and/or 204 can be used in validating that the object is matching a specific object from the database objects collected during the fingerprinting phase or indicate that this object has no match in the database.

In one or more examples of the disclosure, the matching process in steps 202,203 and/or 204 can be done to find the closest database objects' entries to the object and/or rank each entry with respect to how close it is to the object. This will increase the correctness of matching in many cases of object changes due to, but not limited to, the change of shape due to tear and/or wear, using different lighting and/or using imaging programs, technologies and/or resolutions in the search phase different than fingerprinting phase.

In the database object search, in one or more examples of the disclosure, in case the object identification number is known, a comparison will be conducted between the database entries for this object's unique identification and the captured images of the object to validate the match. The object validation programs work in a similar way to the database object search programs in FIG. 2; however, it does not conduct a search. The programs will only compare the images to specific images in the database.

According to an aspect, an objects entry can contain information to track the ownership of the object to include current and/or historical ownership. In one or more examples, blockchain technology can be used to create an immutable ledger of historical and/or current ownership.

In one or more examples of the disclosure the database can include, but not limited to, conventional databases including SQL and/or NoSQL databases, file storage and/or blockchain immutable ledger.

In one or more examples of the disclosure the blockchain technology can be used to validate the accuracy of stored information in the database.

In one or more examples of the disclosure, the blockchain technology can be used to validate the accuracy of information exchanged between different parts of the programs.

In one or more examples of the disclosure, the blockchain technology can be used to encrypt information exchange or saved in any part of the programs.

In one or more examples of the disclosure, in all the steps of the fingerprinting phase and/or the database object search programs in FIG. 1 and FIG. 2, traditional image processing, artificial intelligence and/or machine learning technologies can be used to detect, but not limited to, errors, anomalies, features, colors, similarity and/or type of material.

In one or more examples of the disclosure, in steps 202, 203 and/or 204 of FIG. 2, traditional image processing, artificial intelligence and/or machine learning technologies can be used to compare the captured object with the database entries collected during fingerprinting phase.

In one or more examples of the disclosure, an image captured by the database object search programs and associated to a specific object can be used to update the object's database entries to keep track of the historical changes to the object and/or to be used in identification of the object in future searches. These images can be ingested and/or utilized in similar way to the fingerprinting phase.

In one or more examples of the disclosure, the fingerprinting process can be repeated for the object to update older fingerprints.

In one or more examples of the disclosure, the fingerprinting process can be repeated for the object to have track of fingerprinting over time.

In one or more examples of the disclosure, when the multiple fingerprints are available for an object over time, the database object search programs can consider the changes over time as a weighted parameter in search process.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. A method of image processing comprising the steps of:
generating one or more images of an object utilizing a first technology;
transferring the one or more images of the object to a processor;
utilizing the processor to capture the one or more images of the object;
labeling the one or more images of the object with one or more object properties; and
saving the one or more images of the object to a database.

2. The method of claim 1 further comprising the step of
evaluating the one or more images; and
tracking an ownership of the object which can be current or historical ownership;
wherein the step of tracking the ownership of the object utilizes blockchain technology.

3. The method of claim 2 further comprising the step of utilizing the blockchain technology to encrypt information related to the ownership of the object.

4. The method of claim 1 wherein the captured one or more images saved to the database comprises a two-dimensional image.

5. The method of claim 4 wherein the one or more images saved to the database comprises a partial two-dimensional image.

6. The method of claim 1 wherein the one or more images saved to the database comprises a three-dimensional image.

7. The method of claim 6 wherein the one or more images saved to the database comprises a partial three-dimensional image.

8. The method of claim 1 wherein the first technology utilized for generating one or more images of the object is selected from a group comprising microscopy, x-ray diffraction, or 3D x-ray diffraction.

9. The method of claim 1 wherein the one or more images are associated with an identification number.

10. The method of claim 1 wherein the one or more images are associated with one or more object properties of the object.

11. The method of claim 10 wherein the one or more object properties is selected from the group including an identification number, a manufacturer of the object, a manufacturing date of the object, an alloy property of the object, or an owner of the object.

12. The method of claim 1 wherein the step of labeling the one or more images of the object with one or more object properties occurs manually.

13. The method of claim 1 wherein the step of labeling the one or more images of the object with one or more object properties occurs automatically.

14. The method of claim 1 further comprising the step of utilizing a cloud computing environment to perform one or more steps of the image processing.

15. The method of claim 1 wherein the database comprises one or more object entries selected from the group comprising an object unique identification, object original imaging, at least one object feature, a date of addition to the database, an object manufacturing date, an object manufacturer identification, an object specification or an object model number.

16. The method of claim 1 further comprising the step of
performing imaging the object utilizing a second technology; and
capturing one or more second imaging features of the object.

17. The method of claim 16 further comprising the step of evaluating the captured images of the object during imaging of the object utilizing the second technology with the first set of images captured during the first imaging using the first technology.

18. The method of claim 16 wherein the first technology is substantially similar to the second technology.

19. The method of claim 16 wherein the method further comprises the step of utilizing AI to evaluate the captured images of the object by utilizing the second technology.

20. The method of claim 16 further comprising the step of identifying similar images and/or features collected in the database during the first imaging process with the one or more second imaging features of the object.

21. The method of claim 20 further comprising the step of identifying images and/or features that will be used to pull the corresponding object information from the database collected during the first technology.

22. The method of claim 16 further comprising the step of validating that the object is matching a specific object from the database object collected during the first technology.

23. The method of claim 1 wherein the database comprises an SQL database.

24. The method of claim 16 further comprising the step of tracking one or more historical changes to the object.
